(19) United States
(12) Patent Application Publication
(10) Pub. No.: US 2010/0183364 A1
(43) Pub. Date: Jul. 22, 2010

(54) ATTACHMENT MECHANISM

(75) Inventor: Gershon Harif, Ramat Gan (IL)

Correspondence Address: THE NATH LAW GROUP, 112 South West Street, Alexandria, VA, 22314, US

(73) Assignee: NO SCREW LTD., Holon (IL)

(21) Appl. No.: 12/663,209

(22) PCT Filed: Jun. 5, 2008
(86) PCT No.: PCT/IL08/00776

§ 371 Date: Dec. 4, 2009

(30) Foreign Application Priority Data
Jun. 6, 2007 (IL) 183721
Jun. 20, 2007 (IL) 184091
Jul. 19, 2007 (IL) 184742
Oct. 10, 2007 (IL) 186569
Mar. 11, 2008 (IL) 190100
Mar. 19, 2008 (IL) 190316

(51) Int. Cl. F16B 7/00; B23P 11/00

(52) U.S. Cl. 403/295; 403/292; 29/525.08

(57) ABSTRACT

Provided is an attachment arrangement including a first member for securely attaching thereon a second member having a top face, a bottom face and formed with a second member bore having an inner surface extending between the top and the bottom face. The first member includes an attaching portion defined by a bottom surface and at least one side wall angled to the bottom surface, an attaching portion bore with a bore axis, and a securing mechanism. The securing mechanism includes a securing pin within the attaching portion bore and has a body with an outer surface extending between a proximal end and a distal end of the body. The securing mechanism further includes a displacement arrangement for axially displacing the securing pin along the bore axis of the attaching portion bore between at least a first, attaching, position and a second, securing, position.

### FIELD OF THE INVENTION

This invention relates to attachment mechanism, in particular, mechanism adapted to be securely engaged with one another.

### BACKGROUND OF THE INVENTION

The is known a variety of attachment mechanisms adapted to be securely attached to one another in order to hold or clamp an article therebetween. One of the most common of such mechanisms is a bolt and nut arrangement, in which two articles may be secured to one another by passing the bolt therethrough and providing a nut on the opposite end, thereby preventing axial displacement of the two articles with respect ton one another.

### SUMMARY OF THE INVENTION

According to one aspect of the present invention, there is provided An attachment arrangement comprising a first member adapted for securely attaching thereon a second member having a top face, a bottom face and formed with an second member bore having an inner surface extending between said top and said bottom face; said first member comprising an attaching portion defined by a bottom surface and at least one side wall angled to said bottom surface, an attaching portion bore with a bore axis having an open end at the bottom surface of said attaching portion, and a securing mechanism for securing said second member in said attaching portion, said securing mechanism comprising a securing pin received within said attaching portion bore and having a body with an outer surface extending between a proximal end and a distal end of the body and defining a pin axis therealong, and a displacement arrangement adapted for axially displacing said securing pin along the bore axis of said attaching portion bore between at least a first, attaching position in which said distal end protrudes from within the attaching portion bore through said bottom surface into said attaching portion to a first extent so as to allow said second member to be placed within the attaching portion, having its bottom face aligned against said bottom surface, and a second, securing position in which said distal end protrudes from within the attaching portion bore through said bottom surface into said attaching portion to a second extent, greater than said first extent, so as to engage the inner surface of said second member bore, thereby securing said second member in place.

It should be understood that the term ‘aligned’ refers to a configuration in which said bottom face and said bottom surface are generally parallel to one another. It should also be understood that said bottom face and bottom surface do not necessarily have to be in contact with one another, i.e. may be spaced from one another.

In addition, it is to be further understood that the term ‘attaching position’ is used hereinafter to define a position allowing not only attaching of the second member onto the first member, but also disattaching of the second member therefrom, as well as releasing the second member to a certain extent allowing changing orientation thereof.

According to a specific example of the present invention, the arrangement may be such that in both positions said proximal end may be located within said attaching portion bore. Alternatively, according to another example, said attaching portion bore may be adapted for receiving an intermediary arrangement having a bore adapted to receive said securing pin, in which case in both positions, said proximal end located within the bore of said intermediary arrangement.

Said second member may be further formed with a side face, wherein when the second member is secured within the attaching portion of the first member, the securing pin being adapted to apply pressure on the inner surface of said second member bore so as to facilitate firm engagement of said at least one side face with said at least one side wall of said attaching portion.

The arrangement of said securing pin and the inner surface of said second member may be such that the pin axis is angled to the inner surface of said second member to thereby apply pressure to said inner surface in the direction of said at least one side wall, i.e. such that a portion of the second member defined between the inner surface and said at least one side face facing the side wall of said attaching portion is fastened between the distal end of said securing pin and said side wall. Such an arrangement may be achieved by any of the following configurations:
the securing pin has a surface portion pin axis is perpendicular to the bottom surface of said attaching portion and the inner surface of said second member is angled to bottom face thereof;
the pin axis is angled to the bottom surface, i.e. not perpendicular thereto and the inner surface of said second member is perpendicular to said bottom face; and
both the pin axis and the inner surface are angled, i.e. not perpendicular, to the bottom surface of the attaching portion and the bottom face of the second member respectively.

It should also be noted in this connection that the angle between the bottom surface of said attaching portion and said at least one side wall is not limited to an acute angle and may be a straight angle (90°) and may even be an obtuse angle.

Said displacement arrangement may be an arrangement separate from the securing pin adapted to mechanically engage the securing pin, or the proximal end thereof, such that displacement of the arrangement entails displacement of the securing pin in the axial direction. Examples of such arrangement may be a biasing spring, a bolt or a wedge adapted to press against the securing pin.

In particular, when a biasing spring is used as suggested above, it may be arranged such that the securing pin is constantly urged by the biasing spring into said securing position. Thus, switching the securing pin's position to the attaching position may be achieved by simple depression of the biasing spring.

Specifically, in order to release a second member from the first member, depression of the biasing spring may be achieve by applying pressure on the securing pin. According to one example, the second member may be formed such that the second member bore is open at both ends, i.e. at the top and bottom face, wherein a pressure instrument may be second member into the bore through the top face of the second member to apply pressure to the distal end of the securing pin for depression of the biasing spring. According to another example, said securing pin may be formed with a nook and said first member or said second member is formed with a recess, arranged so as to be aligned with said nook at said securing position. Thus, a pressure instrument may be second member into said recess to be received within said nook and apply pressure to said securing pin for depression of the biasing spring.

Alternatively, the securing pin may be integrally formed with the displacement arrangement, such that displacement of the pin in a certain direction entails its axial movement. One example of such an arrangement may be one in which said securing pin is formed with an external thread receivable within an inner thread of said attaching portion bore such that rotation of the pin entails progression thereof along the axial direction. The securing pin may be formed at one of its ends with a bolt head adapted for receiving a rotary instrument such as a screwdriver adapted for rotation of the securing pin.

In particular, said securing pin may be designed such that the distal end thereof is formed with the bolt head, wherein said rotary instrument is adapted to engage the securing pin from the top, i.e. such that is first passes through said second member to engage the bolt head. In such a case, the second member bore may have an opening at both the top and bottom face. Alternatively, said proximal end may be formed with said bolt head wherein said rotary instrument is adapted to engage the securing pin from the bottom, i.e. such that is first passes through the first member to engage the bolt head.

However, as previously defined, in displacement of the securing pin between the attaching position and the securing pin, the distal end of the securing pin, regardless of its being formed with a bolt head or not, is displaced farther away from the bottom surface and into the attaching portion.

The securing mechanism may be formed with an second member bore adapted to receive a securing pin of the securing mechanism, and a bottom and side faces adapted for alignment against corresponding bottom surface and side walls in a manner similar to that previously described. Particularly, the arrangement may be such that the first member is formed with two counter disposed shoulders, each having a side surface of the first member, wherein the second member is securely held in place and prevented from rotating in one direction (e.g. CW) due to the side surface, and to the other direction (CCW) due to the securing pin.

In addition, the bottom surfaces of the first member are not limited to a planar shape and may have a variety of configuration including spiral, helical, circular etc. In particular, when both the first member and the second member are of circular shape, and are formed with corresponding helical bottom face and bottom surface, the arrangement may be such that the second member is allowed to slidingly displace on the first member until it reaches a locking position.

Additionally, the bottom surface of the attaching portion of the first member may have a conical configuration with respect to the central axis thereof, e.g. having an outer edge and an inner edge, the outer edge being positioned axially lower with respect to the inner edge. The bottom face of the mounting portion of the second member may have a corresponding opposite configuration, i.e. having an outer edge and an inner edge, the outer edge being positioned axially higher with respect to the inner edge. Such a configuration may facilitate automatic self centralizing of the second member with respect to the first member.

Said positioning element may be adapted to be aligned with a corresponding positioning portion of said first member. For example, said positioning element may be an extension receivable within a corresponding bore of said first member. The positioning portions of the second member and of the first member may be formed with a bayonet arrangement, for further securing the second member from disengaging from the first member.

Each of said first and second members may be formed with a flanged portion such that when attached to one another, a gap is formed which may be used for clamping an article between the first member and the second member.

It should be understood that the attachment mechanism previously disclosed in not limited to attachment of two members to one another, but also facilitates the secure clamping of a third article therebetween. Thus, the attachment mechanism may be effectively used similarly to a bolt and nut assembly. For example, the attachment mechanism may be used to secure a grindstone adapted to revolve at high revolution speeds.

According to yet another aspect of the present invention there is provided a method for attaching a second member to a first member, said method including:
displacing a securing pin of said first member into a first, attaching position in which the distal end thereof protrudes from within the attaching portion bore through said bottom surface into said attaching portion to a first extent;
placing said second member onto said attaching portion such that the bottom face thereof is aligned with the bottom surface of said attaching portion; and
displacing said securing pin into a second, securing position in which said distal end protrudes from within the attaching portion bore through said bottom surface into said attaching portion to a second extent, greater than said first extent, so as to engage the inner surface of said second member bore, thereby securing said second member in place;

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an isometric view of an attachment arrangement according to one embodiment of the present invention;

FIG. 2 is an enlarged view of a detail I shown in FIG. 1;

FIG. 3 is a top view of the attachment mechanism shown in FIG. 1;

FIG. 4 is a cross-sectional view taken along line B-B in FIG. 3;

FIG. 5 is a cross-sectional view taken along line A-A in FIG. 3;

FIG. 6 is an enlarged view of detail C shown in FIG. 3;

FIG. 7 is an isometric view of a part of the attachment mechanism shown in FIG. 1;

FIG. 8 is an enlarged view of detail D shown in FIG. 7;

FIG. 9 is an isometric view of an attachment arrangement according to another embodiment of the present invention;

FIG. 10 is a top view of the attachment mechanism shown in FIG. 9;

FIG. 11 is a cross-sectional view taken along line B-B in FIG. 10;

FIG. 12 is a cross-sectional view taken along line A-A in FIG. 10;

FIG. 13 is an isometric view of a part of an attachment arrangement according to another embodiment of the present invention; and

FIG. 14 is an isometric view of an assembled attachment mechanism a part of which is shown in FIG. 13

### DETAILED DESCRIPTION OF EMBODIMENTS

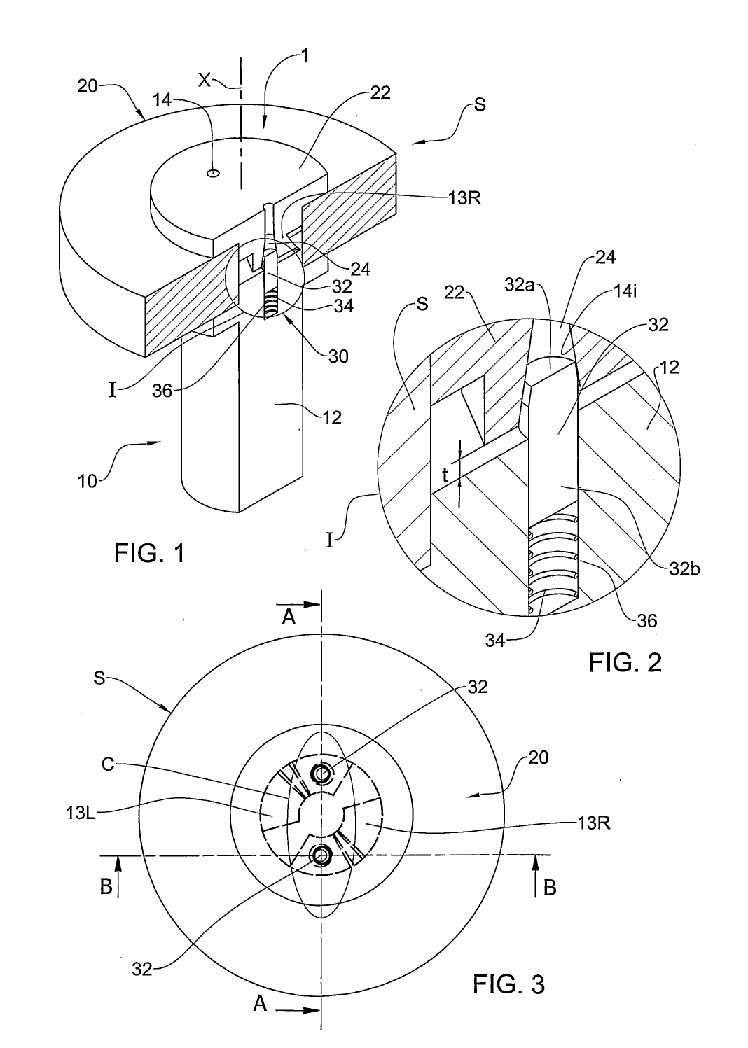

With reference to FIGS. 1 to 8 an attachment arrangement generally designated 1 is shown comprising a first member 10 attached to a second member 20 by a securing mechanism 30, and clamping therebetween a grindstone S.

The first member 10 is formed with a circular base surface 12 having a central axis X, a left and a right shoulder 13L, 13R respectively axially extending therefrom, and a flange portion 16 located adjacent the base surface on a side opposite the shoulders 13L, 13R and having a diameter greater than that of the base surface. Each shoulder 13 is formed with a shoulder bore 36 adapted to house a securing pin 32 and a biasing spring 34 and an inclined side surface 15 having a helical shape.

The second member 20 is similarly formed with a base surface 22, two shoulders 23 having a similar configuration to that of the first member 10, and a flange portion 26 having a diameter greater than that of the base surface 22. Each shoulder 23 is formed with side helical surface 25 and a conical bore 24 adapted to receive therein the securing pin 32.

In assembly, the arrangement is such that the first and second member 10, 20 are arranged such that the shoulders thereof are facing one another, and the securing pins 32 of the first member 10 are received within the bores 24 of the second member 10.

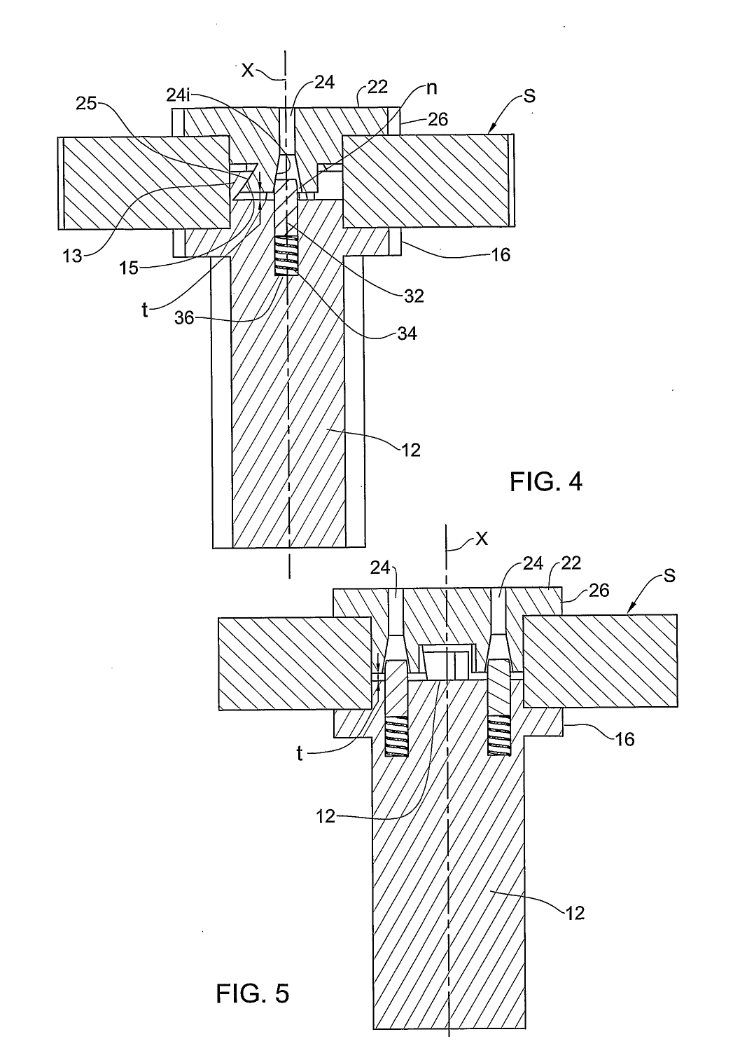

With particular reference to FIGS. 2 and 4, in the assembled position, the securing pin 32 engages and bears against the inner surface 24i of the second member 20, and is urged axially upwards by the biasing spring 34. It is also observed that axial displacement of the securing pin 32 entails lateral displacement of the second member 20, and consequently the side face 25 thereof towards the side surface 15 of the first member, thereby securing the second member 20 in place. Since each of the members 10, 20 has a circular symmetry, the second member 20 is urged to rotate about the central axis to be come firmly secured to the first member 10.

However, it is noted that while axial upward displacement of the securing pin 32 entails lateral displacement of the second member 20, an attempt to laterally displace the second member 20 with respect to the first member will not entail axial downward displacement of the securing pin 32. This is due to the angle between the inner surface 24i of the bore 24 and the central axis, which is close to 0°. In the present example, the angle α≅10°.

When attaching the second member 20 to the first member 10, it is first required to displace the securing pins 32 to an attachment position, allowing placing the second member 20 onto the first member 10. Displacing into an attachment position may be achieved by depressing the securing pin 32 such that it is received within the bore 36 to an extent in which the distal end de thereof does not prevent attachment of the second member 20 onto the first member.

Depression of the securing pin 32 may be achieved either by using an instrument to apply pressure on the distal end de of the securing pin 32, or by applying pressure using the second member 20 itself. Fir example, the following steps of attachment may take place:
placing the second member 20 onto the first member such that the side surfaces 25 thereof engage the distal ends de of the securing pins 32;
pressing down on the securing pins 32 using the second member 20 until depressed to an attachment position; and
rotating the second member 20 with respect to the first member 10 until the securing pins 32 are free to enter the bore 24 and secure the second member 20 in place.

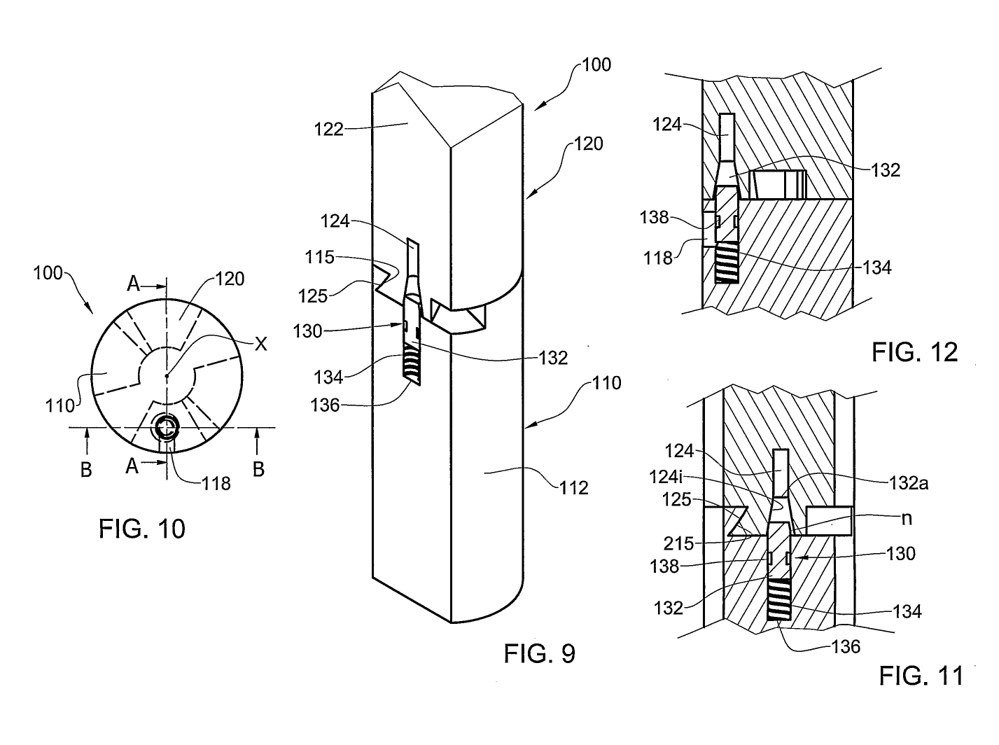

In order to release the second member 20 from the first member 10, the securing pins 32 are required to be depressed back into an attachment position. This may be achieved by inserting an instrument from the open side of the bore 24 and depressing the securing pin 32, or alternatively, as will be shown with reference to FIGS. 9 to 12, by inserting an instrument into a side recess formed in one of the members 10, 20 and aligned with a special nook in the securing pin 32 (shown FIG. 12).

When the attachment mechanism 1 is used to clamp an article, such as the grindstone S, the thickness of the grindstone S determines the contact area between the securing pin 32 and the inner surface 24i, and between the side surfaces 15, 25 of the two members. It is evident that the thicker the grindstone S, the smaller the contact area. Thus, in order to provide secure clamping, the grindstone S may assume thicknesses ranging from a low thickness in which there is full overlap between the side surfaces 15, 25 to a high thickness in which there is almost no overlap, and the distal end of the shoulder 23 is adjacent the distal end of the shoulder 13.

It is also noted in FIG. 4 that there exists a gap n between the first member 10 and the second member 20. This gap allows a certain amount of elasticity and may vary during rapid revolution of the grindstone.

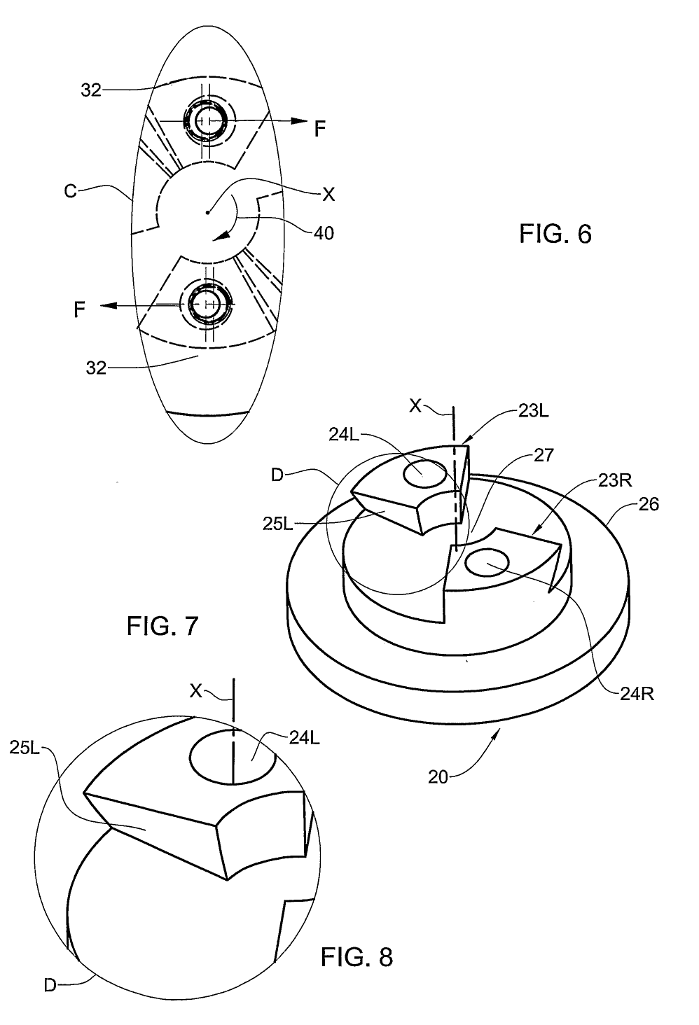

With particular reference to FIG. 6, it is observed that the attachment mechanism disclosed herein is used for a rotation operation, wherein the securing pins 32 are arranged such that they apply pressure in opposite directions as noted by arrows F.

Turning now to FIGS. 9 to 12, another embodiment of the attachment mechanism generally designated 100 is shown comprising a first member 110, and a second member 120 attached thereto using a securing mechanism 130. The attachment mechanism 100 may be used for connecting two shafts together.

The first member 110 is formed with a circular base surface 112 having a central axis X, a left and a right shoulder 113L, 113R respectively axially extending therefrom. Each shoulder 113 is formed with a shoulder bore 136 adapted to house a securing pin 132 and a biasing spring 134 and an inclined side surface 115 having a helical shape.

The second member 120 is similarly formed with a base surface 122, two shoulders 123 having a similar configuration to that of the first member 110. Each shoulder 123 is formed with side helical surface 125 and a conical bore 124 adapted to receive therein the securing pin 132.

The attachment mechanism 100 operates in much the same manner as the attachment mechanism 10 previously disclosed with the difference being that only one securing pin 132 is used as opposed to two in previous embodiment. This however, does not damage the attachment mechanism due to the engagement between the side surfaces 115, 125 of the first and second member 110, 120 respectively.

In addition, the bores 124 are only open at one end thereof. Thus, in order to depress the securing pin 132 to an attachment position, the first member 110 is formed with a side bore 118, and the securing pin 132 is formed with a nook. The arrangement is such that when in the securing position, the nook 138 of the securing pin 132 is accessible through the side bore 118, allowing an operator to depress the securing pin 132 and release the second member 120 from the first member 110.

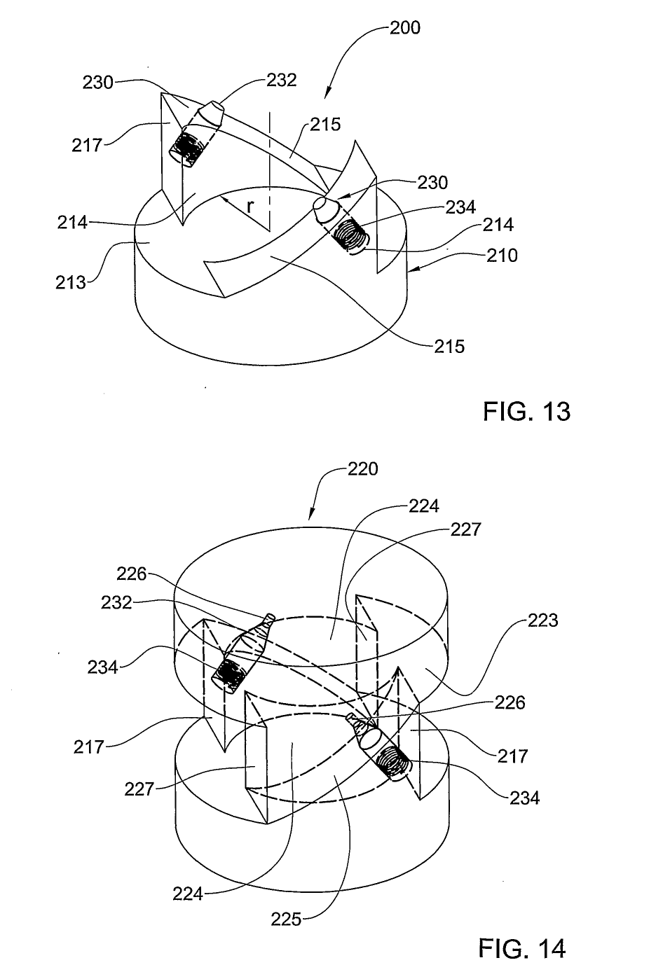

Turning now to FIGS. 13 and 14, another embodiment of the attachment mechanism generally designated 200 is shown in which the first and second member 210, 220 are formed with shoulders 214, 224 each having an inclined surface 215, 225. The first member 210 is formed with bores 236 open at the inclined surface 215 and adapted to receive therein a securing mechanism 230 similar to that previously disclosed. The second member 220 is similarly formed with bores 226 at the inclined surfaces 225 thereof adapted to receive the securing pin 232 in a manner similar to that previously described.

The difference in the present embodiment lies in the fact that the same inclines surface 215, 225 in from which the securing pins 232 protrudes is used as the side surface having a function similar to that of the side surface denoted by 25 in FIG. 7.

However, the securing pins 232 in the present embodiment may be inclined with respect to the surface 215, i.e. not perpendicular thereto, and may have an angle such 10 that the distal ends thereof face outwardly, or inwardly from the central axis X, for firm securing of the two members 210, 220 to one another.

In assembly, the attachment mechanism 200 is similar to that disclosed with respect to the attachment mechanism 10 and 100.

1.-26. (canceled)

27. An attachment arrangement comprising
a first member configured for securely attaching thereon a second member having a top face, a bottom face and formed with a second member bore having an inner surface extending between the top and the bottom face;
the first member comprising an attaching portion defined by a bottom surface and at least one side wall angled with respect to the bottom surface, an attaching portion bore with a bore axis having an open end at the bottom surface of the attaching portion, and a securing mechanism for securing the second member in the attaching portion,
the securing mechanism comprising a securing pin received within the attaching portion bore and having a body with an outer surface extending between a proximal end and a distal end of the body and defining a pin axis therealong, and a displacement arrangement configured for axially displacing the securing pin along the bore axis of the attaching portion bore between at least a first, attaching, position in which the distal end protrudes from within the attaching portion bore through the bottom surface into the attaching portion to a first extent so as to allow the second member to be placed within the attaching portion, having its bottom face aligned against the bottom surface, and a second, securing, position in which the distal end protrudes from within the attaching portion bore through the bottom surface into the attaching portion to a second extent, greater than the first extent, to engage the inner surface of the second member bore, thereby securing the second member in place.

28. The attachment arrangement according to claim 27, wherein in both the attachment position and the securing position, the securing pin remains in engagement with the first member.

29. The attachment arrangement according to claim 27, wherein the attachment position is configured to allow at least any one of the following:
attaching the second member to the first member; and
detaching the second member from the first member.

30. The attachment arrangement according to claim 27, wherein in both the attachment position and the securing position, the proximal end is located within the attaching portion bore.

31. The attachment arrangement according to claim 27, wherein the second member further comprises a side face, wherein when the second member is secured within the attaching portion of the first member, the securing pin is configured to apply pressure on the inner surface of the second member bore to facilitate firm engagement of the at least one side face with the at least one side wall of the attaching portion.

32. The attachment arrangement according to claim 27, wherein the pin axis is angled with respect to the inner surface of the second member such that a portion of the second member defined between the inner surface and the at least one side face facing the side wall of the attaching portion is fastened between the distal end of the securing pin and the side wall.

33. The attachment arrangement according to claim 32, wherein the securing pin comprises a surface portion pin axis that is perpendicular to the bottom surface of the attaching portion and the inner surface of the second member is angled with respect to the bottom face thereof.

34. The attachment arrangement according to claim 32, wherein the pin axis is not perpendicular thereto and the inner surface of the second member is perpendicular to the bottom face.

35. The attachment arrangement according to claim 32, wherein both the pin axis and the inner surface are not perpendicular to the bottom surface of the attaching portion and the bottom face of the second member, respectively.

36. The attachment arrangement according to claim 27, wherein the displacement arrangement is an arrangement separate from the securing pin configured to mechanically engage the securing pin, or the proximal end thereof, such that displacement of the arrangement displaces the securing pin in the axial direction.

37. The attachment arrangement according to claim 36, wherein the displacement mechanism is a biasing spring.

38. The attachment arrangement according to claim 37, wherein the arrangement is such that the securing pin is constantly urged by the biasing spring into the securing position.

39. The attachment arrangement according to claim 38, wherein switching the securing pin's position to the attaching position is achieved by simple depression of the biasing spring.

40. The attachment arrangement according to claim 27, wherein the first member is formed with two counter disposed shoulders, each having a side surface, wherein the second member is securely held in place and prevented from rotating in a first direction due to the side surface, and in a direction opposite to the first direction due to the securing pin.

41. The attachment arrangement according to claim 40, wherein the side surfaces of the first member comprise a helical shape.

42. The attachment arrangement according to claim 41, wherein both the first member and the second member comprise a circular shape and further comprise corresponding helical side surfaces.

43. The attachment arrangement according to claim 42, wherein the bottom surface of the attaching portion of the first member has a conical configuration with respect to the central axis thereof.

44. The attachment arrangement according to claim 43, wherein the bottom surface comprises an outer edge and an inner edge, the outer edge being positioned axially lower with respect to the inner edge.

45. The attachment arrangement according to claim 43, wherein the configuration facilitates automatic self centralizing of the second member with respect to the first member.

46. The attachment arrangement according to claim 27, wherein each of the first and second members comprises a flanged portion such that when attached to one another, a gap is formed between the flanged portions allowing the clamping of an article therebetween.

47. The attachment arrangement according to claim 46, wherein each shoulder is formed with an inclined bottom surface configured to provide additional lateral support to the second member.

48. The attachment arrangement according to claim 47, wherein the first member comprises a round shape and a central axis, and wherein the securing pin is inclined to a first angle due to the inclination of the bottom surface, and is further inclined with a second angle with respect to the central axis.

49. A method for attaching a second member of an attachment arrangement to a first member of the attachment arrangement, the attachment arrangement according to claim 27, the method comprising:
i. displacing a securing pin of the first member into a first, attaching, position in which the distal end thereof protrudes from within the attaching portion bore through the bottom surface into the attaching portion to a first extent;
ii. placing the second member onto the attaching portion such that the bottom face thereof is aligned with the bottom surface of the attaching portion; and
iii. displacing the securing pin into a second, securing position in which the distal end protrudes from within the attaching portion bore through the bottom surface into the attaching portion to a second extent, greater than the first extent, so as to engage the inner surface of the second member bore, thereby securing the second member in place.
